(19) United States
(12) Patent Application Publication
(10) Pub. No.: US 2010/0133095 A1
(43) Pub. Date: Jun. 3, 2010

(54) Electrolysis System for an Internal Combustion Engine

(76) Inventor: Jeff Selano, Dallas, GA (US)

Correspondence Address: STEVEN L. SCHMID, 1824 HICKORY TRACE DRIVE, FLEMING ISLAND, FL, 32003, US

(21) Appl. No.: 12/326,081

(22) Filed: Dec. 1, 2008

(51) Int. Cl. C25B 9/18; C25B 9/00; F02B 43/08

(52) U.S. Cl. 204/238; 204/240; 123/3

(57) ABSTRACT

Disclosed is an electrolysis system for producing one or more gases for an internal combustion engine for enhancing combustion. The system uses stacked electrode plates including neutral plates for generating an oxygen and hydrogen gas mixture. The stacked plates substantially fill an electrolysis cell containing an electrolytic solution which is recycled and cooled.

### TECHNICAL FIELD

The present system relates to an electrolysis system for an internal combustion engine and in greater detail the system relates to an electrolysis system for producing one or more gases for an internal combustion engine for enhancing combustion.

### BACKGROUND

Modern gasoline and diesel engines are more efficient and less polluting than similar engines of even a few years ago. However, due to the increased total number of vehicles in use, levels of air pollution continue to rise even in light of more efficient and clean running vehicles. Therefore, there has been increasing pressure to develop vehicles which have lower emissions, and thus are less polluting than conventional automotive technology permits. This has spurred development of alternate fuel technologies such as electric cars and vans, natural gas and propane fuelled vehicles, hydrogen cell vehicles and the like.

While a number of these technologies are promising, some are still a long way from commercial implementation, and others appear to have reached the limit of present design capabilities without yielding a consumer acceptable product. Therefore, attention has refocused on conventional gas and diesel burning engines, and ways to render them more pollution free and efficient.

The addition of hydrogen and oxygen gases as fuel can increase the efficiency of an internal combustion engine and reduces pollution considerably. Both advantages appear to be the byproduct of faster flame speed that is as much as nine times that of gasoline, resulting in more complete combustion of the fuel in the combustion chamber. The amount of soot (semi-burnt hydrocarbons), nitrous oxide, carbon monoxide, and other pollutants is accordingly reduced, while output energy increases, for a greater fuel efficiency and horsepower.

One way to adopt hydrogen and oxygen as a fuel additive is to store the gases in tanks installed on a vehicle, with hoses connecting the tanks to the engine. However, tank storage of these volatile gases presents a persistent safety hazard, since there is always a risk of gas leak and explosion. It also requires regular trips to a service station for replenishment, which is inconvenient.

Further, the prevailing service station network would need to be retrofitted at great cost to supply these gases, which would also require widespread coordination of standards that could unduly delay acceptance of the technology. As a result of these problems with tank storage, various attempts have been made to develop systems in which the gases could be generated on board the vehicle itself, using well-known technologies such as electrolysis, for use by the engine as needed.

### SUMMARY

The present system is directed to an electrolysis system for producing one or more gases for an internal combustion engine for enhancing combustion. The system uses stacked electrode plates including neutral plates for generating a oxygen and hydrogen gas mixture or Brown's gas which is the product of water electrolysis. The stacked plates substantially fill an electrolysis cell containing an electrolytic solution which is recycled and cooled.

In greater detail, the system includes an electrolysis cell generating one or more combustion enhancing gases from an electrolytic solution, the electrolysis cell includes a housing having inclined sloping walls for directing the combustion gases out through an opening in the housing. The housing further includes at least three electrodes within the housing. The system further includes a trap fluidly connected to the electrolysis cell for collecting and holding the solution. The trap further emits one or more combustion enhancing gases whereby the trap can be fluidly connected to the intake of the internal combustion engine. Additionally, the trap is fluidly connected to the electrolysis cell for delivering the solution to the cell.

In a further embodiment, the system includes a cooling assembly fluidly connected to the trap and the cell such that the electrolytic solution is cooled before being delivered to the cell. The cooling assembly includes a radiator and a fan operatively aligned with the radiator whereby air is drawn through the radiator. In one embodiment at least eight electrodes are included within the housing, wherein at least four of the electrodes are neutral. The neutral electrodes are paired side by side with a positive electrode on a first side of the pair and a negative electrode on a second side of the pair.

A pump may also be included for recirculating the electrolytic solution within the system. An electronic controller for controlling operation of the system may be included. The controller may control the rate of flow of the combustion enhancing gases from the cell to the engine can be increased when the engine is operating at higher speed. Further contemplated is the use of a plurality of electrolysis cells connected in series.

An additional embodiment includes a system for producing one or more gases for an internal combustion engine for enhancing combustion comprising an electrolysis cell generating one or more combustion enhancing gases from an electrolytic solution. The electrolysis cell includes a housing having inclined sloping walls for directing the combustion gases out through an opening in the housing. The housing including a first portion and a second portion, the first portion having a recess formed within and the second portion comprising a plate fitted over the first portion forming a substantially watertight chamber within.

A plurality of stacked electrodes formed from metal plates are fitted within the chamber wherein at least one of the electrodes is neutral. A trap is included which is fluidly connected to the electrolysis cell for collecting and holding the solution. The trap further directs the one or more combustion enhancing gases to the intake of the internal combustion engine. The trap is also further fluidly connected to the electrolysis cell for delivering the solution to the cell. Additionally, a pump is fluidly connected to the system for recirculating the electrolytic solution within. The cooling assembly is fluidly connected to the trap and the cell whereby the electrolytic solution is cooled before being delivered to the cell. The cooling assembly includes a radiator and a fan operatively aligned with the radiator whereby air is drawn through the radiator.

### DRAWINGS

In the drawings:

FIG. 1 is an embodiment of the present electrolysis system including the electrolysis cell, trap, cooling assembly and pump for enhancing combustion by providing oxygen and hydrogen from electrolysis;

FIG. 2 depicts the first and second portion of the electrolysis cell and the sloping sides or beveled sides leading up to the exit point to aid in removing gasses from the cell;

FIG. 3 illustrates an embodiment of the electrodes as plates depicting both the positive and negative plates and the neutral plates; and

FIG. 4 depicts the plates placed in the recess of the first portion of the housing or electrolysis cell.

### DETAILED DESCRIPTION

Disclosed is a system directed to an electrolysis system for producing one or more gases for an internal combustion engine for enhancing combustion. The system uses stacked electrode plates including neutral plates for generating an oxygen and hydrogen gas mixture or Brown's gas which is the product of water electrolysis. The stacked plates substantially fill an electrolysis cell containing an electrolytic solution which is recycled and cooled.

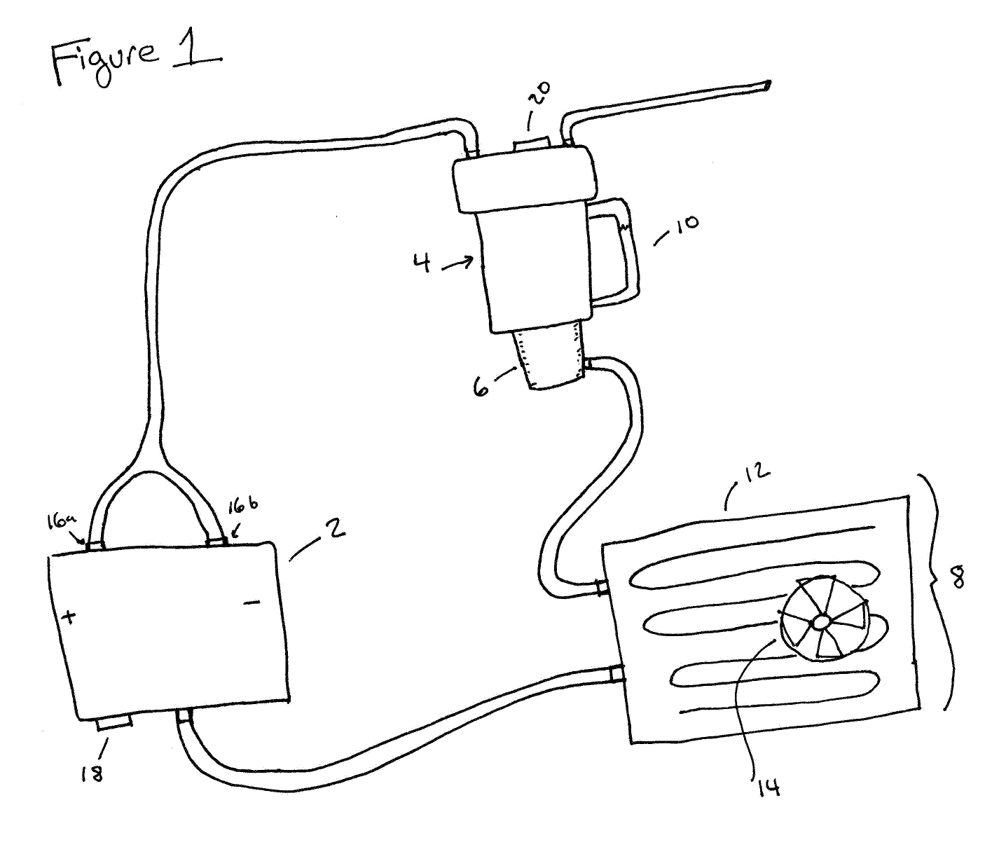

Turning now to the attached drawings, wherein like reference numerals will refer to like elements throughout, FIGS. 1-4 illustrate the various embodiments of the present system.

FIG. 1 illustrates an embodiment of the present electrolysis system including the electrolysis cell 2, trap 4, cooling assembly 8 and pump 6 for enhancing combustion by providing oxygen and hydrogen from electrolysis. The electrolysis cell 2 may one or more exit ports 16(a-b) for delivering gasses to the trap 4 and then to combustion engine (not shown). Typically, the more exit ports 16(a-b), the greater the amount gas flow from the electrolysis cell 2. The electrolysis cell 2 may have a drain plug 18 to aid in cleaning out the electrolysis cell 2.

The trap 4 is fluidly connected to the electrolysis cell 2 typically via flexible tubing capable of conveying a fluid including gas and liquid. The trap 4 can separate the liquid and gas generated from the electrolysis cell 2. The trap 4 allows gas to flow on to the engine while retaining and then recycling the liquid back to the electrolysis cell 2. Additionally, the trap 4 may act as a reservoir for the electrolytic solution so that the system can be filled via the trap 4. The trap 4 includes a fill plug 20 for filling the trap 4. A level indicator 10 may be added to the trap 4 to determine if the system needs additional electrolytic solution. The electrolytic solution can be most any solution for example but not limited to vinegar, soda and distilled water, or sodium and water.

A pump 6 may be attached to the trap 4 in the embodiment shown. However, the pump 6 for circulating the electrolytic solution in the system may be located at any position within the system to circulate the electrolytic solution. Circulating the solution aids in cooling the solution and the electrolysis cell 2. The pump 6 may be fluidly connected to the cooling assembly 8. Fluid connection may be the same in all the system, but such is not required so long as fluid may be moved as in a conduit.

The cooling assembly 8 may be comprised of a radiator 12 of most any size. Typically, the radiator is sized to fit easily within most automobiles. Optionally, a fan 14 may be added to the radiator 12 to aid in cooling.

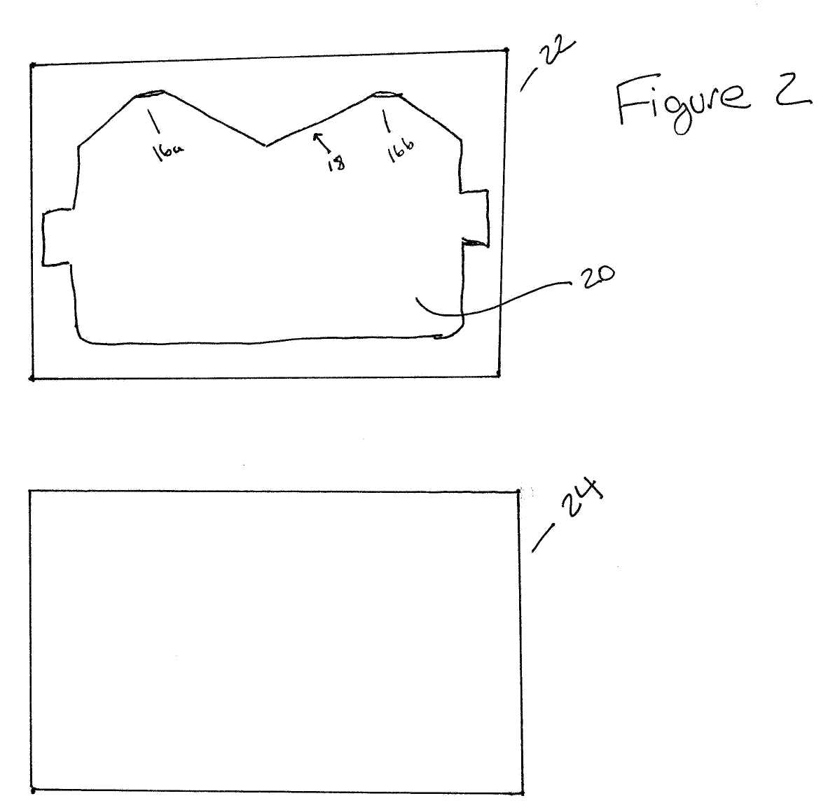

FIG. 2 depicts the first portion 22 and the second portion 24 of the housing of the electrolysis cell 2. The first portion 22 includes a recess 20 into which the electrodes 26(a-b) reside and the electrolytic solution. The housing is formed by the joining of the first portion 22 and the second portion 24. The second portion 24 is typically a flat, relatively thin portion when compared to the first portion 22. Typically the portions 22, 24 are joined using heat and glue. However other fastening means may be used. Both portions (22, 24) may be formed from a plastic. The same is true for the other components. Furthermore, the components may be formed from a metal

The first portion 22 includes sloping sides 18 or beveled sides 18 sloping up to the exits ports 16(a-b) to aid in moving the gas created in the electrolysis cell 2 up and out the exit ports 16(a-b). Illustrated in FIG. 2, there are two exit ports 16(a-b) with their respective bevels 18 directing the gas to the port 16.

The electrolysis cell 2 is formed in an embodiment as a “brick” configuration. The cell 2 has a slim profile much like a book. The electrolysis cell 2 having this configuration can be stacked and added in a series to produce more gas without creating a large footprint within the vehicle. Furthermore, having the trap 4 as a reservoir reduces the needed size of the electrolysis cell 2 and the volume of solution needed.

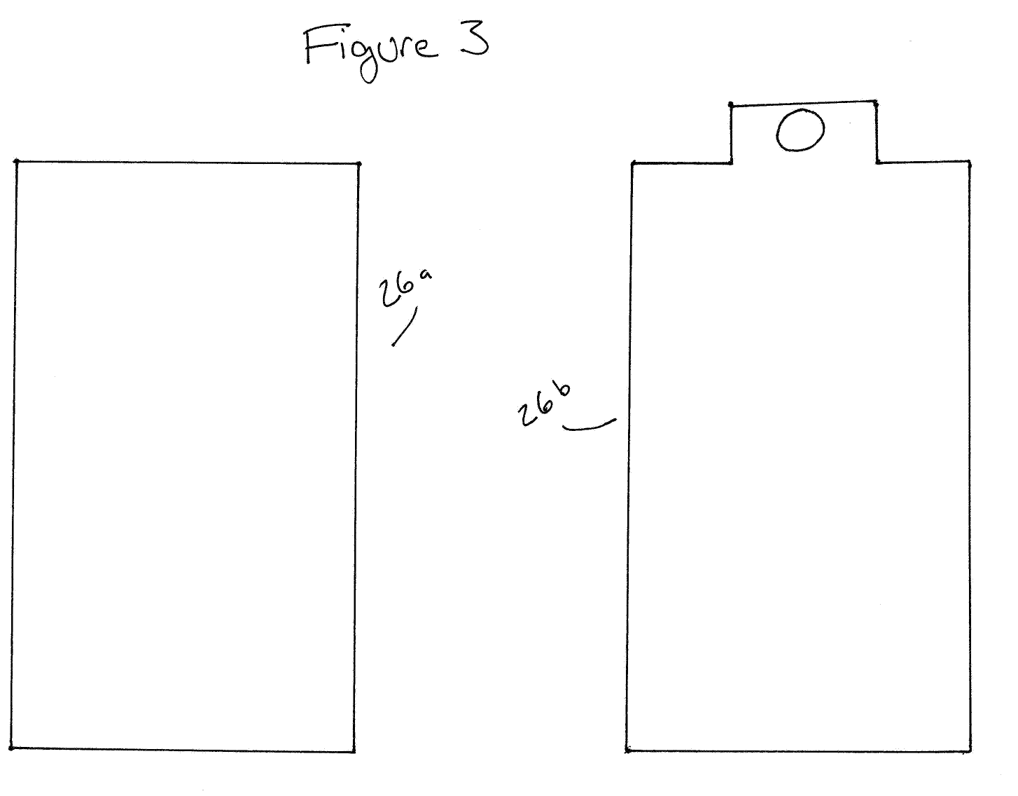

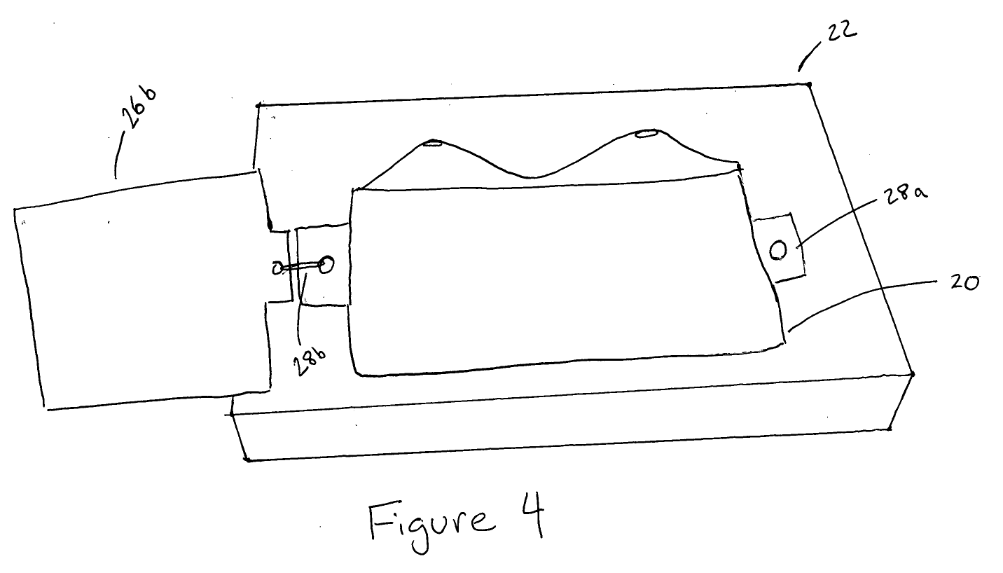

FIG. 3, depicts the electrodes 26(a-b). Typically, the electrodes are formed from sheet metal and are flat for stacking within the electrolysis cell 2. The electrodes 26(a-b) may be formed from stainless steel. The electrode 26(b) with a hole functions as the electrode for the positive and negative electrode. The hole connects the electrode 26(b) to positive and negative terminals 28(a-b) running into the electrolysis cell 2 as shown in FIG. 4.

As shown in FIG. 4, the electrodes 26(a-b) are stacked metal plates and reside within the recess 20 of the first portion 22. Typically, the number of electrodes 26(a-b) may range from any number such eight in one embodiment. In one embodiment, the neutral plates are paired side by side and having a positive plate on a first side of the pair and a negative plate on a second side of the pair. Between the electrodes 26(a-b) may be placed an insulation strip 30 between the electrodes 26(a-b).

The system may further comprise an electronic controller (not shown) for controlling operation of the system and wherein the rate of flow of the combustion enhancing gases from the cell 2 to the engine can be increased when the engine is operating at higher speed.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A system for producing one or more gases for an internal combustion engine for enhancing combustion comprising:
an electrolysis cell generating one or more combustion enhancing gases from an electrolytic solution, the electrolysis cell including a housing and at least three electrodes within the housing, the housing having inclined sloping walls for directing the combustion gases out through an opening in the housing; and
a trap fluidly connected to the electrolysis cell for collecting and holding the solution and the trap emitting one or more combustion enhancing gases whereby the trap can be fluidly connected to the intake of the internal combustion engine and the trap further fluidly connected to the electrolysis cell for delivering the solution to the cell.

2. The system of claim 1, further including a cooling assembly fluidly connected to the trap and the cell whereby the electrolytic solution is cooled before being delivered to the cell.

3. The system of claim 2, wherein the cooling assembly includes a radiator.

4. The system of claim 3, further including a fan operatively aligned with the radiator whereby air is drawn through the radiator.

5. The system of claim 1, wherein at least eight electrodes are included within the housing and wherein at least four of the electrodes are neutral.

6. The system of claim 5, wherein the neutral electrodes are paired side by side and having a positive electrode on a first side of the pair and a negative electrode on a second side of the pair.

7. The system of claim 1, further including a pump for recirculating the electrolytic solution within the system.

8. The system of claim 1 further including an electronic controller for controlling operation of the system.

9. The system of claim 1, wherein the rate of flow of the combustion enhancing gases from the cell to the engine can be increased when the engine is operating at higher speed.

10. The system of claim 1, further including a plurality of electrolysis cells.

11. A system for producing one or more gases for an internal combustion engine for enhancing combustion comprising:
an electrolysis cell generating one or more combustion enhancing gases from an electrolytic solution, the electrolysis cell including a housing having a first portion and a second portion, the first portion having a recess formed within and the second portion comprising a plate fitted over the first portion forming a substantially watertight chamber within;
a plurality of electrodes fitted within the chamber wherein at least one of the electrodes is neutral;
a trap fluidly connected to the electrolysis cell for collecting and holding the solution and the trap emitting one or more combustion enhancing gases whereby the trap can be fluidly connected to the intake of the internal combustion engine and the trap further fluidly connected to the electrolysis cell for delivering the solution to the cell;
a pump fluidly connected to the system for recirculating the electrolytic solution within the system; and
a cooling assembly fluidly connected to the trap and the cell whereby the electrolytic solution is cooled before being delivered to the cell.

12. The system of claim 11, wherein the cooling assembly includes a radiator.

13. The system of claim 12, further including a fan operatively aligned with the radiator whereby air is drawn through the radiator.

14. The system of claim 11, wherein the electrodes are metal plates stacked upon each other and substantially filling the chamber.

15. The system of claim 12, wherein the number of stacked metal plates are eight and wherein the neutral plates are paired side by side and having a positive plate on a first side of the pair and a negative plate on a second side of the pair.

16. The system of claim 11, wherein the pump is fluidly connected to the trap.

17. The system of claim 11, wherein the housing having inclined sloping walls for directing the combustion gases out through an opening in the housing.

18. The system of claim 11, wherein a plurality of cells are connected in series.

19. The system of claim 11, wherein the cell draws less than 10 amps.

20. A system for producing one or more gases for an internal combustion engine for enhancing combustion comprising:
an electrolysis cell generating one or more combustion enhancing gases from an electrolytic solution, the electrolysis cell including a housing having inclined sloping walls for directing the combustion gases out through an opening in the housing, the housing including a first portion and a second portion, the first portion having a recess formed within and the second portion comprising a plate fitted over the first portion forming a substantially watertight chamber within;
a plurality of stacked electrodes formed from metal plates and fitted within the chamber wherein at least one of the electrodes is neutral;
a trap fluidly connected to the electrolysis cell for collecting and holding the solution and the trap emitting one or more combustion enhancing gases whereby the trap can be fluidly connected to the intake of the internal combustion engine and the trap further fluidly connected to the electrolysis cell for delivering the solution to the cell;
a pump fluidly connected to the system for recirculating the electrolytic solution within the system; and
a cooling assembly fluidly connected to the trap and the cell whereby the electrolytic solution is cooled before being delivered to the cell, the cooling assembly including a radiator and a fan operatively aligned with the radiator whereby air is drawn through the radiator.
